(19) United States
(12) Patent Application Publication
(10) Pub. No.: US 2026/0355902 A1
(43) Pub. Date: Nov. 12, 2026

(54) COMBINED CUTTERHEAD-BASED SYSTEM FOR CUTTING REINFORCED CONCRETE AND METHOD THEREFOR

(71) Applicant: SHANDONG UNIVERSTIY, Jinan, Shandong (CN)

(72) Inventors: Shucai LI, Jinan (CN); Bin LIU, Jinan (CN); Biao LI, Jinan (CN); Mengmeng HU, Jinan (CN); Bo ZHANG, Jinan (CN); Hu YU, Jinan (CN); Chuang HUANG, Jinan (CN); Liuqi GU, Jinan (CN); Tongyuan LIU, Jinan (CN)

(73) Assignee: SHANDONG UNIVERSTIY, Jinan, Shandong (CN)

(21) Appl. No.: 19/475,312

(22) PCT Filed: Oct. 30, 2023
(86) PCT No.: PCT/CN2023/127951

§ 371 Date: Oct. 14, 2025

(30) Foreign Application Priority Data
Apr. 11, 2023 (CN) 2023104048437

(51) Int. Cl. B24C 1/04

(52) U.S. Cl. CPC B24C 1/045

(57) ABSTRACT

A combined cutterhead-based system for cutting reinforced concrete comprises a combined cutterhead and a control unit, wherein the combined cutterhead is an abrasive water jet-mechanical combined cutterhead for shield machine, and the control unit is configured to control the combined cutterhead to perform stepwise cyclic cutting on the reinforced concrete; wherein, in each cutting cycle, the control unit is configured first to control the combined cutterhead to rotate without advancing, to perform a plurality of times of cutting by using abrasive water jets, for a total depth of joint-cuttings on a reinforced concrete structure to reach a preset depth; and then configured to turn off the abrasive water jets, configured to control shield cutters that cooperate with the abrasive water jets to implement same-trajectory cutting, and configured to control remaining shield cutters to break concrete between rebar breakpoints and separate out rebar.

The present invention claims priority to Chinese Patent Application No. 2023104048437, filed with the China National Intellectual Property Administration on Apr. 11, 2023 and entitled “COMBINED CUTTERHEAD-BASED SYSTEM FOR CUTTING REINFORCED CONCRETE AND METHOD THEREFOR”, which is incorporated herein by reference in its entirety.

### TECHNICAL FIELD

The present invention relates to the field of reinforced concrete cutting technologies, and in particular, to a combined cutterhead-based system for cutting reinforced concrete and a method therefor.

### BACKGROUND

The statements in this part provide only background information related to the present invention, but do not necessarily constitute the related art.

Tunneling by using shield machines has advantages such as high automation, rapid tunneling, and minimal impact on the surrounding environment. However, with the increasing density of urban buildings and extensive development of underground space, shield tunneling faces more complex engineering conditions. When encountering an existing underground reinforced concrete structure, such as a pile foundation, an underground diaphragm wall, or a reinforced region at tunnel portals, conventional mechanical shield tunneling can cause engineering problems such as rebar entanglement on a cutterhead, abnormal damage to a cutter, and machine jamming, resulting in low safety and slow construction. To address the challenge of insufficient penetration through reinforced concrete by a shield machine, a concept of cutting by using a mechanical shield cutter with the help of an abrasive water jet is proposed. Relative experimental studies have been reported and have demonstrated the effectiveness of this method to some extent. In addition, a design scheme of a shield abrasive water jet-mechanical combined cutterhead has also been disclosed.

Reinforced concrete, as a composite material, presents significant differences in mechanical properties between the rebar and the concrete. During shield tunneling, the concrete is easily broken through cutting, while the rebar is hardly likely to be cut off due to high strength. After the concrete that coats and fixes the rebar is broken, the rebar is separated out, further increasing cutting difficulty. This causes the engineering problems such as entanglement on a cutterhead and screw machine jamming. Therefore, a shield abrasive water jet-mechanical combined cutterhead can effectively cut the rebar in the reinforced concrete into shorter rebar segments, so as to smoothly remove the rebar and avoid engineering problems. This is crucial for removing reinforced concrete obstacles for efficient tunneling.

In the related art, critical challenges that limit the full utilization of the abrasive water jet on the combined cutterhead include how the combined cutterhead performs cutting, how to determine combined cutting parameters, and how to reduce energy consumption of the abrasive water jet. For example, polar radii (distances from the center of the cutterhead) of a plurality of water nozzles on the combined cutterhead are greatly different, so that transverse velocities of the water nozzles are significantly different as the cutterhead rotates, leading to significantly different cutting capabilities of the abrasive water jets (the cutting capability decreases rapidly as the linear velocity increases). If parameters such as a diameter of the water nozzle and a pump pressure are improperly selected, it is difficult to ensure consistent auxiliary effects of all water jets. Consequently, the rebar at some cutting points is hardly cut off.

### SUMMARY

To resolve at least one technical problem in the background, a first aspect of the present invention provides a combined cutterhead-based system for cutting reinforced concrete, and a second aspect of the present invention provides a combined cutterhead-based method for cutting reinforced concrete. The present invention can match an abrasive water jet-mechanical combined cutterhead on a shield machine, coordinate combined cutting abilities of a plurality of abrasive water jet-mechanical cutters on the combined cutterhead, ensure efficient cutting of rebar, and balance energy consumption, advancing industrial application of the combined cutting technique.

To achieve the foregoing objective, the present invention provides the following technical solutions.

The first aspect of the present invention provides a combined cutterhead-based system for cutting reinforced concrete.

The combined cutterhead-based system for cutting reinforced concrete, including: a combined cutterhead and a control unit, wherein the combined cutterhead is an abrasive water jet-mechanical combined cutterhead of shield machine, and the control unit is configured to control the combined cutterhead to perform stepwise cyclic cutting on the reinforced concrete; wherein, in each cutting cycle, the control unit is configured to: first control the combined cutterhead to rotate without advancing, to perform a plurality of times of cutting by using abrasive water jets, for a total depth of joint-cuttings on a reinforced concrete structure to reach a preset depth; and then control the abrasive water jets to be turned off, control shield cutters that cooperate with the abrasive water jets to implement cutting with same trajectories as the abrasive water jets, and control remaining shield cutters to break concrete between rebar breakpoints and separate out rebar.

The stepwise cyclic cutting of the abrasive water jet-mechanical cutters includes: in a cutting process of the combined cutterhead, total tunneling footage for the reinforced concrete is divided into tunneling segments with equal lengths, and a cutting process for each tunneling segment is referred to as a cutting cycle. Cutting is performed in two steps in each cutting cycle. In step 1 (a jet cutting step), the cutterhead only rotates without advancing and first performs a plurality of times of cutting by using the abrasive water jets, for the total depth of the joint-cuttings of the reinforced concrete structure to reach Lⱼ. In step 2 (a mechanical tunneling step), the abrasive water jets are turned off, the shield cutters that cooperate with the abrasive water jets are controlled to implement cutting (same-trajectory cutting) to a cutting depth Lₘ, to ensure that rebar is cut off at a time, and the remaining shield cutters break concrete between rebar breakpoints and separate out the rebar. Due to cyclic cutting, an actual cutting depth of the abrasive water jets in a cutting cycle is Lₘ. For a reinforced concrete structure, for example, a pile foundation, the distribution of rebar is complex in the reinforced concrete, and the rebar is encountered frequently in a tunneling direction. During cutting by using the abrasive water jet, all rebar materials are considered as a cutting target. A value of Lⱼ is greater than that of Lₘ, and a difference between Lⱼ and Lₘ is less than a diameter of the rebar. A standoff height h of a water nozzle is a sum of a structural standoff height h₁ and a standoff height h₂ formed in a cutting process, wherein h₂=Lⱼ−Lₘ. In the jet cutting step, a value of an advance speed S₁ of the cutterhead is 0, and a value of a rotational speed R₁ of the cutterhead is low, which may be the lowest rotational speed.

As an implementation mode, the control unit is configured to: in the case of the plurality of times of cutting, set different numbers of cuts for the abrasive water jets with different mounting polar radii, and adjust depths of the joint-cuttings on the reinforced concrete structure that are made by the abrasive water jets.

The advantage of the foregoing technical solution lies in that cutting by the plurality of the abrasive water jets on the cutterhead can be coordinated, thereby improving cutting efficiency.

As an implementation mode, the cutting depth obtained by using the abrasive water jets is greater than a cutting depth obtained by using the shield cutters that cooperates with the abrasive water jets, and a difference between the two cutting depths is less than a diameter of the rebar.

As an implementation mode, a standoff height of a water nozzle is a sum of a structural standoff height and a standoff height formed in a cutting process, wherein the standoff height formed in the cutting process=the cutting depth obtained by using the abrasive water jets−the cutting depth obtained by using the shield cutters that cooperate with the abrasive water jets.

As an implementation mode, based on obtained test data of rebar cutting, value ranges of key parameters for efficient rebar cutting by water jets is determined using a rebar joint-cutting depth as an evaluation indicator.

As an implementation mode, the key parameters for cutting by the abrasive water jets include a transverse velocity, a pump pressure, a standoff height, a nozzle diameter, a number of cuts, and an abrasive concentration.

As an implementation mode, a model for predicting the rebar joint-cutting depth is obtained through fitting based on the key parameters for cutting by the abrasive water jets; and a number of cuts of each nozzle with each diameter-pump pressure combination in a cutting cycle is calculated based on grouping of estimated ranges of the diameter of the water nozzle and the pump pressure, the model for predicting the rebar joint-cutting depth that is obtained through fitting, and an actual cutting depth of the abrasive water jet in each cutting cycle is calculated, and a list is made, to obtain a diameter-pump pressure-number of cuts combination that meets a cutting requirement.

The key parameters (the transverse velocity v, the pump pressure P, the standoff height h, the nozzle diameter d, the number n of cuts, and the abrasive concentration η) for cutting by the abrasive water jet are fitted to obtain the following prediction formula of the rebar joint-cutting depth Dⱼ:

Dⱼ=k₁nv^{k}^{₂}h^{k}^{₃}p^{k}^{₄}d^{k}^{₅}; (1)

wherein, k₁ to k₅ are fitting coefficients. The abrasive concentration η also greatly affects cutting performance of the abrasive water jet. Considering both the cutting performance and the abrasive consumption, a proper value is usually selected for the abrasive concentration, and the abrasive concentration is not used as a variable to participate in parameter optimization. Based on Formula (1), energy consumption of each water nozzle in a cutting cycle is calculated:

$${W}_{j} = \frac{C {πρ}_{w} {tL}_{m}}{{k}_{1} {k}^{{k}_{3}}} \cdot \frac{{d}^{2} {P}^{1.5}}{{v}^{{k}_{2}} {P}^{{k}_{4}} {d}^{{k}_{5}}} ; \qquad ( 2 )$$

wherein, C is an empirical constant, ρ_{w} is the density of water, and t is time consumed for cutting rebar once by the water nozzle on the combined cutterhead. The time t consumed for one-time cutting by each water nozzle is the same, that is, time for the cutterhead to rotate by the same angle is the same. In addition, after the design of the combined cutterhead is completed and the stepwise cutting method is determined, Lₘ and h are fixed values. Therefore, the comparison of energy consumption between water nozzles only needs to be performed according to the following formula:

$${W}_{j 0} = \frac{{d}^{2} {P}^{1.5}}{{v}^{{k}_{2}} {P}^{{k}_{4}} {d}^{{k}_{5}}} ; \qquad ( 3 )$$

The advantage of the foregoing technical solution lies in that, during water jet parameter optimization, a basic form of the model for predicting the rebar joint-cutting depth that is obtained based on the key parameters of the abrasive water jet is provided, providing guidance for fitting for cutting performance of the abrasive water jet by using limited test data, and serving as a crucial basis for parameter optimization.

For a completely made abrasive water jet-mechanical combined cutterhead, the standoff height of the water nozzle has been determined in the stepwise cyclic cutting process, and the cutting transverse velocity of each water nozzle may be obtained through calculation based on a designed polar radius of the water nozzle on the cutterhead and a rotational speed of the cutterhead. Parameters that need to be optimized are the diameter d of the water nozzle, the pump pressure P, and the number n of cuts. Estimated ranges of the diameter of each water nozzle and the pump pressure are listed according to step (1). The outermost water nozzle on the cutterhead has a maximum transverse velocity, limiting cutting efficiency of the abrasive water jet on the cutterhead, so that a maximum nozzle diameter and a maximum pump pressure are selected from proper value ranges of the nozzle parameters. For a nozzle with a small mounting polar radius inside the cutterhead, large estimated ranges are selected for the diameter and the pump pressure.

As an implementation mode, when the water nozzles have a plurality of diameter-pump pressure-number of cuts combinations, a combination with the lowest energy consumption is finally determined through energy consumption calculation.

The advantage of the foregoing technical solution lies in that, through calculation of energy consumption of each water nozzle in a cutting cycle, cutting efficiency can be improved, and energy consumption can be the lowest.

The advantage of the foregoing technical solution lies in that the problem of inconsistent cutting performance caused by greatly different transverse velocities of the abrasive water jets with different polar radii can be resolved. Because the water nozzles with different mounting polar radii have the same rotational angular velocity when rotating with the cutterhead, a larger mounting polar radius indicates a higher transverse velocity. However, as the transverse velocity increases, the capability of the abrasive water jet cutting rebar decreases sharply. If the abrasive water jet parameters are selected indiscriminately, it is difficult to ensure that depths of joint-cuttings formed on the rebar cut by the abrasive water jets with different polar radii are the same. Consequently, partial rebar is hardly cut off by the mechanical cutter, which limits tunneling efficiency of the cutterhead. Therefore, different water jets are coordinated through parameter optimization to have the same cutting performance. In other words, the same rebar joint-cutting depth in the jet cutting step is the key to ensuring combined cutting efficiency.

The second aspect of the present invention provides a combined cutterhead-based method for cutting reinforced concrete.

The combined cutterhead-based method for cutting reinforced concrete, including:
controlling a combined cutterhead to perform stepwise cyclic cutting on the reinforced concrete; wherein,
in each cutting cycle, first controlling the combined cutterhead to rotate without advancing, to perform a plurality of times of cutting by using abrasive water jets, for a total depth of joint-cuttings of a reinforced concrete structure to reach a preset depth; and then controlling the abrasive water jets to be turned off, controlling shield cutters that cooperate with the abrasive water jets to implement a same-trajectory cutting (i.e., cutting with same trajectories as the abrasive water jets), and controlling remaining shield cutters to break concrete between rebar breakpoints and separate out rebar.

As an implementation mode, in the case of the plurality of times of cutting, different numbers of cuts are set for the abrasive water jets with different mounting polar radii, and depths of the joint-cuttings on the reinforced concrete structure that are made by the abrasive water jets are adjusted.

Compared with the related art, the present invention has the following beneficial effects:
(1) The present invention provides stepwise cyclic cutting by using the abrasive water jet-mechanical cutter. In the jet cutting step, joint-cuttings with a required depth are formed by cutting the rebar by the abrasive water jet for a plurality of times, avoiding failure of the jet to effectively help the cutter due to an insufficient depth of the joint-cuttings formed through single cutting. In addition, in the case of the plurality of times of cutting, different numbers of cuts can be set for the abrasive water jets with different mounting polar radii, and depths of the joint-cuttings on the rebar that are made by the abrasive water jets may be adjusted. This coordinates the cutting performance of the plurality of water jets on the cutterhead. Moreover, a method for efficiently determining value ranges of construction step parameters, cutterhead parameters, and abrasive water jet parameters that are involved in the stepwise cyclic cutting is provided, refining a basic framework of a method for combined and efficient cutting on reinforced concrete.
(2) The present invention provides a basic form of the model for predicting the rebar joint-cutting depth that is obtained based on the key parameters of the abrasive water jets, providing guidance for fitting for cutting performance of the abrasive water jets by using limited test data, and serving as a crucial basis for parameter optimization. In addition, through calculation of energy consumption of each water nozzle in a cutting cycle, cutting efficiency can be improved, and energy consumption can be the lowest.
(3) According to the present invention, the optimization of the nozzle diameter-pump pressure-number of cuts is performed through grouping and listing based on an estimated range of the key parameters of each water nozzle, which has a simple implementation process; and compared with a computer-based intelligent optimization algorithm, this can easily form a normalized parameter optimization table and guide, making it more friendly for frontline designers.

Some of advantages of the additional aspects of the present invention are given in the following description, and some become apparent from the following description or are learned through practice of the present invention.

### BRIEF DESCRIPTION OF THE DRAWINGS

The accompanying drawings of this specification that constitute a part of the present invention are used to provide a further understanding of the present invention. Exemplary embodiments of the present invention and descriptions thereof are used to explain the present invention, and do not constitute any inappropriate limitation to the present invention.

FIG. 1 is a schematic diagram of a position relationship between an abrasive water jet-mechanical combined cutterhead of shield machine and a pile foundation according to the present disclosure;

FIG. 2 is a structural diagram of the abrasive water jet-mechanical combined cutterhead of shield machine according to the present disclosure;

FIG. 3 is a structural diagram of an abrasive water jet-mechanical combined cutter according to the present disclosure;

FIG. 4 is a side view of a layout of an abrasive water jet-mechanical combined cutter on the combined cutterhead according to the present disclosure;

FIG. 5 is a flowchart of stepwise cyclic cutting by using the combined cutterhead according to the present disclosure; and

FIG. 6 is a schematic diagram of a method for efficiently cutting reinforced concrete by using the combined cutterhead according to the present disclosure.

### DETAILED DESCRIPTION

The following further describes the present invention with reference to the accompanying drawings and the embodiments.

It should be noted that the following detailed descriptions are all exemplary and are intended to provide further descriptions of the present invention. Unless otherwise indicated, all technical and scientific terms used herein have the same meaning as would normally be understood by a person of ordinary skill in the art of the present invention.

It should be noted that the terms used herein are merely for describing specific implementations, but are not intended to limit exemplary implementations according to the present invention. As used herein, unless otherwise clearly indicated in the context, a singular form is also intended to include a plural form. In addition, it should be further understood that the terms “include” and/or “comprise” that are used in this specification indicate the presence of a feature, a step, an operation, a device, a component, and/or a combination thereof.

In the present invention, to resolve the problem of a poor effect of cutting reinforced concrete in the background, a method for cutting reinforced concrete that can match a shield abrasive water jet-mechanical combined cutterhead is urgently required, to coordinate combined cutting of a plurality of abrasive water jet-mechanical cutters on the combined cutterhead, ensure efficient cutting of rebar, and balance energy consumption, so as to advance industrial application of the combined cutting technique.

A basic idea for designing the combined cutterhead of the present invention is as follows:
(1) With rebar cutting at fixed points as a target, a length of a rebar segment is determined based on a capability of a shield screw machine removing the rebar segment, based on which a plurality of water nozzles are arranged on the cutterhead in a radial direction.
(2) A mechanical cutter is equipped for each water nozzle on the cutterhead to perform same-trajectory cutting, to produce an effect of damage stacking by the abrasive water jet-mechanical cutter.
(3) The mechanical cutters that cooperate with the abrasive water jets are elevated, to ensure a fixation effect on the rebar by the concrete during cutting.

### Example 1

The present example provides a combined cutterhead-based system for cutting reinforced concrete, including: a combined cutterhead and a control unit, wherein the combined cutterhead is an abrasive water jet-mechanical combined cutterhead of shield machine, and the control unit is configured to control the combined cutterhead to perform stepwise cyclic cutting on the reinforced concrete; wherein,
in each cutting cycle, the control unit is configured to: first control the combined cutterhead to rotate without advancing, to perform a plurality of times of cutting by using abrasive water jets, for a total depth of joint-cuttings of a reinforced concrete structure to reach a preset depth; and then control the abrasive water jets to be turned off, control shield cutters that cooperate with the abrasive water jets to implement cutting with same trajectories as the abrasive water jets (same-trajectory cutting), and control remaining shield cutters to break concrete between rebar breakpoints and separate out rebar.

A metro line in a city is used as an example below:

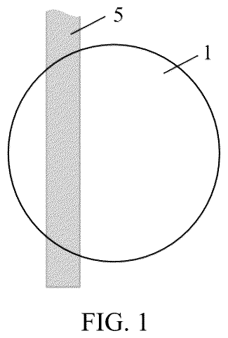

In a city, a metro line is deeply buried below a water level. A shield machine is used for tunneling. The shield machine encounters an unavoidable existing bridge pile foundation during construction, and needs to penetrate a bored pile with a diameter of 1.0 m, where a diameter of main rebar is 22 mm, and strength of concrete is C30. For conventional mechanical cutting, it is difficult to effectively cut off rebar, and a construction process poses significant disturbance to a bridge, leading to a high risk. Therefore, for this project, the abrasive water jet-cutter combined cutterhead of shield machine 1 is used, and a method for efficiently cutting reinforced concrete is provided to guide combined tunneling. Relative positions of a pile foundation 5 and the combined cutterhead of shield machine 1 are shown in FIG. 1. A horizontal distance between a center line of the pile foundation and a tunnel center is approximately 1.6 m.

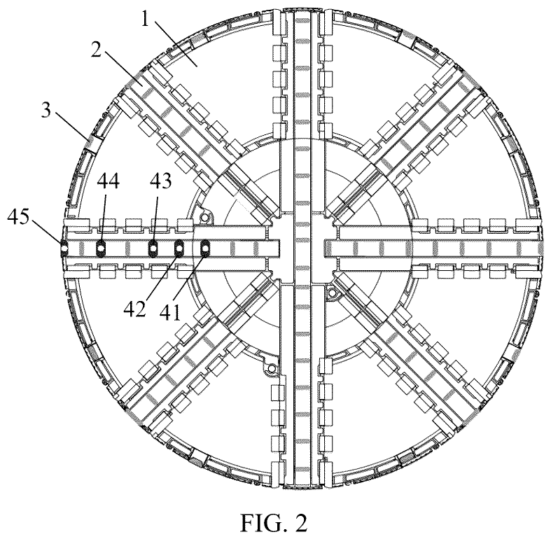

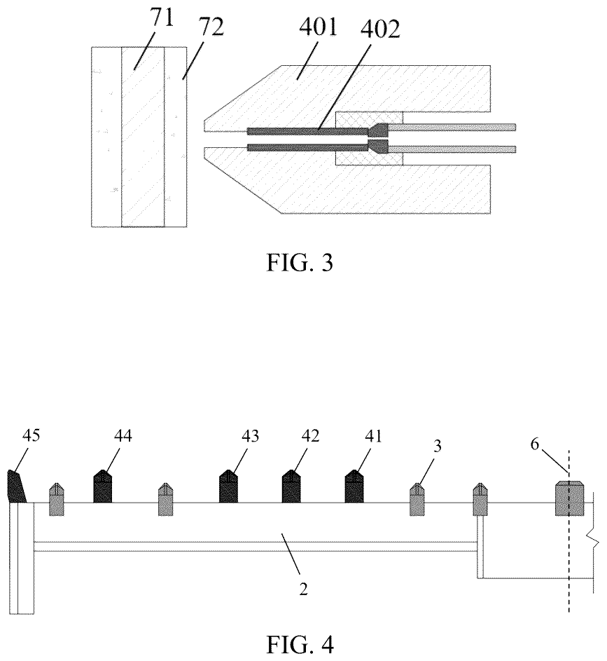

As shown in FIG. 2, the combined cutterhead is of a structure including eight spokes and two face plates, with a diameter of 6124 mm, and a total of sixty-five shell cutters 3 and five combined cutters 41 to 45 are arranged, and distances (mounting polar radii) between the five combined cutters and a center of the cutterhead are respectively 1204 mm, 1544 mm, 1884 mm, 2224 mm, and 2274 mm. As shown in FIG. 3, a shell cutter 401 and a water nozzle 402 are integrated together on each of the combined cutters. A value of a standoff height h₁, of the water nozzle, formed due to a structure of the combined cutter is 5 mm. This ensures same-trajectory cutting of the shell cutters and the abrasive water jets, and reduces a standoff height of the abrasive water jets for cutting rebar 71 and concrete 72. In addition, the shell cutter 401 protects the water nozzle well. A layout of the combined cutters 41 to 45 on the spoke 2 is shown in FIG. 4. For rebar at each of the joint-cuttings made by the abrasive water jets to be cut off first, the combined cutters are elevated, to implement cutting ahead of the shell cutters 3. According to the specification of the shield machine, a minimum rotational speed of the combined cutterhead is 0.1 rpm, a minimum tunneling speed is 1.0 mm/min, and an inner diameter of a screw machine that matches the combined cutterhead is 910 mm.

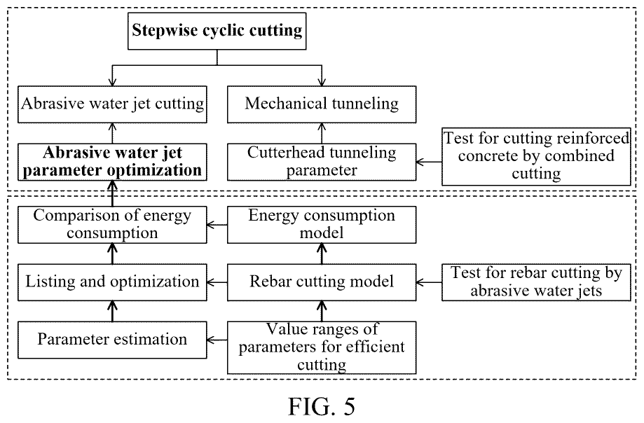

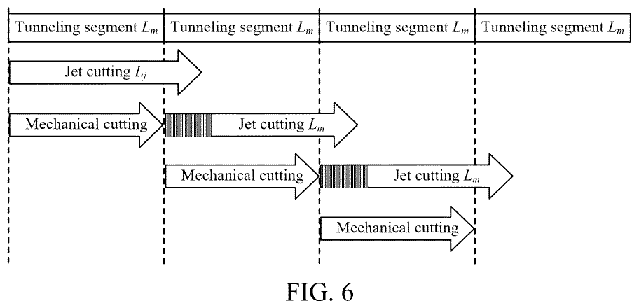

FIG. 5 shows an implementation process of a method for efficiently cutting reinforced concrete by using a combined cutterhead, generally including two parts: stepwise cyclic cutting and water jet parameter optimization. The stepwise cyclic cutting of the combined cutterhead means that total tunneling footage for the reinforced concrete is divided into tunneling segments Lₘ with equal lengths, and a cutting process for each tunneling segment is referred to as a cutting cycle, as shown in FIG. 6.

Cutting is performed in two steps in each cutting cycle. In step 1 (a jet cutting step), the cutterhead only rotates without advancing and performs a plurality of times of cutting by using the abrasive water jets, for a total depth of joint-cuttings of the reinforced concrete structure to reach Lⱼ. An actual cutting depth of the abrasive water jets is Lⱼ only in the first cutting cycle, and an actual cutting depth of the abrasive water jets in each subsequent cycle is Lₘ, where a value of Lⱼ is greater than that of Lₘ. In step 2 (a mechanical tunneling step), the abrasive water jets are turned off, and the shell cutters implement cutting to a total cutting depth Lₘ. The shell cutters arranged in the combined cutters first cut rebar, to ensure that the rebar is cut off at a time, and the remaining shell cutters on the cutterhead primarily breaks concrete between rebar breakpoints and separates out the rebar that has been cut off.

In the jet cutting step, a value of an advance speed S₁ of the cutterhead is 0, and a value of a rotational speed R₁ of the cutterhead is the lowest rotational speed 0.1 rpm.

Because a standoff height of the abrasive water jet for efficiently cutting the rebar should not exceed 50 mm, a value of Lⱼ should not be greater than 50 mm. In the present example, a value of Lⱼ is 40 mm.

Because this project is located below the underground water level, the abrasive water jet cuts the reinforced concrete through underwater wet cutting. To determine related mechanical parameters and tunneling parameters, a combined cutting test is carried out, where the abrasive water jet first submerges a joint-cutting, and then the shield cutter cuts the reinforced concrete along the joint-cutting. That the rebar is cut off is used as an evaluation indicator. According to a test result, in the mechanical tunneling step, a value range of an advance speed S₂ is preferably 1 mm/min to 4 mm/min, and a value range of a rotational speed R₂ of the cutterhead is preferably 0.5 rpm to 2 rpm. In the present example, a value of S₂ is 3 mm/min, and a value of the rotational speed R₂ of the cutterhead is 1 rpm. According to the combined cutting test result, when the rebar can be cut off in a combined way, a standoff height h₂ (h₂=Lⱼ−Lₘ) formed in a cutting process should not be less than 10 mm, and should not be greater than a diameter of the rebar. In the present example, a value of h₂ is 10 mm. Therefore, in the jet cutting step, a standoff height h of the abrasive water jet is h=h₁+h₂=15 mm, and a construction step parameter is Lₘ=Lⱼ−h₂=30 mm.

A process of parameter optimization for the abrasive water jets in the jet cutting step is as follows:
(1) A rebar cutting test is carried out under submerged conditions for the key parameters (the transverse velocity v, the pump pressure P, the standoff height h, the nozzle diameter d, the number n of cuts, and the abrasive concentration η) of cutting by the abrasive water jets, with a rebar joint-cutting depth as an evaluation indicator. The following value ranges of parameters of the abrasive water jets for efficiently cutting rebar are obtained: the transverse velocity is not greater than 2 m/min, the pump pressure is 280 MPa to 380 MPa, the diameter of the water nozzle is 0.33 mm to 0.68 mm, the standoff height is not greater than 50 mm, the abrasive mass concentration is not less than 13%, and the number of cuts is not less than 1 (where the joint-cutting depth is directly proportional to the number of cuts).

In the value ranges of parameters of the abrasive water jet for efficiently cutting rebar, fitting is performed according to the result of the wet cutting of the rebar by the abrasive water jet, to obtain a prediction formula of the rebar joint-cutting depth Dⱼ:

Dⱼ=0.112nv^{-0.988}h^{-0.435}p^{0.725}d^{1.351}. (4)

Considering both the cutting performance and the abrasive consumption, the abrasive concentration η is a fixed value 13%, and is not used as a variable to participate in parameter optimization. Formula (4) is put into Formula (2) in the present invention, to obtain energy consumption of each water nozzle in a cutting cycle:

Wⱼ=0.112⁻¹CtLₘv^{0.988}h^{0.435}d^{0.649}p^{0.775}; (5)

wherein, C is an empirical constant, and t is time consumed for cutting rebar once by the water nozzle on the combined cutterhead. The time t consumed for one-time cutting by each water nozzle is the same, that is, time for the cutterhead to rotate by the same angle is the same. A value of Lₘ is 30 mm, and a value of h is 15 mm, which are all fixed values. Therefore, the comparison of energy consumption between water nozzles only needs to be performed according to the following formula:

Wⱼ₀=v^{0.988}d^{0.649}p^{0.775}. (6)

(2) The transverse velocity of each water nozzle is calculated based on a mounting polar radius of the combined cutter and a rotational speed of the cutterhead in the jet cutting step, and then estimated ranges of the diameter of each water nozzle and the pump pressure are listed in the value ranges of parameters of the abrasive water jet for efficient cutting, as shown in Table 1. The combined cutter 45 has a maximum transverse velocity, and thus is a control nozzle that affects cutting efficiency of the abrasive water jet on the cutterhead. Large values are selected for both the nozzle diameter and the pump pressure, which are respectively 0.68 mm and 380 MPa.

TABLE 1
Estimated ranges of the diameter of the
water nozzle and the pump pressure

| | Transverse | Diameter | Pump pressure |
|---|---|---|---|
| Number | velocity/(m/min) | range/(mm) | range/(MPa) |
| 41 | 0.8 | 0.33-0.60 | 280-380 |
| 42 | 1.0 | 0.40-0.68 | 280-380 |
| 43 | 1.2 | 0.50-0.68 | 280-380 |
| 44 | 1.4 | 0.50-0.68 | 280-380 |
| 45 | 1.9 | 0.68 | 380 |

(3) In Table 1, the diameter of the water nozzle is divided into five groups, which are respectively 0.33 mm, 0.40 mm, 0.50 mm, 0.60 mm, and 0.68 mm, and the pump pressure is divided into three groups, which are respectively 280 MPa, 330 MPa, and 380 MPa. Then, a number of cuts of each water nozzle with each diameter-pump pressure combination in a cutting cycle is calculated according to Formula (1) and an actual cutting depth Lₘ of the abrasive water jets in each cutting cycle, as listed in Table 2. Maximum values in the estimated ranges are selected for the diameter and pump pressure of the outermost water nozzle on the combined cutter, to ensure overall cutting efficiency of the cutterhead. Based on a number of cuts of the outermost water nozzle, a diameter and a pump pressure that are not greater than those corresponding to the number of cuts are selected for another water nozzle, to obtain a diameter-pump pressure-number of cuts combination that meets a cutting requirement.

TABLE 2
Parameter screening table for water nozzle diameter-pump pressure combinations

| Diameter/ | Cutting times of water nozzle in each combined cutter | | | | | Pump pressure/ |
|---|---|---|---|---|---|---|
| (mm) | #41 | #42 | #43 | #44 | #45 | (MPa) |
| 0.33 | 19 | | | | | |
| 0.40 | 15 | 19 | | | | |
| 0.50 | 11 | 14 | 16 | 19 | | 280 |
| 0.60 | 9 | 11 | 13 | 15 | | |
| 0.68 | | 9 | 11 | 13 | | |
| 0.33 | 17 | | | | | |
| 0.40 | 13 | 16 | | | | |
| 0.50 | 10 | 12 | 15 | 17 | | 330 |
| 0.60 | 9 | 10 | 11 | 13 | | |
| 0.68 | | 8 | 10 | 11 | | |
| 0.33 | 15 | | | | | |
| 0.40 | 12 | 15 | | | | |
| 0.50 | 9 | 11 | 13 | 15 | | 380 |
| 0.60 | 7 | 9 | 10 | 12 | | |
| 0.68 | | 7 | 9 | 10 | 14 | |

(4) In step (3), each water nozzle usually has a plurality of diameter-pump pressure-number of cuts combinations that meet the requirement. For example, the water nozzle of the combined cutter 44 has the following parameters that meet the requirement: 0.68 mm-280 MPa-13 times, 0.60 mm-330 MPa-13 times, 0.68 mm-330 MPa-11 times, 0.60 mm-380 MPa-12 times, and 0.68 mm-380 MPa-10 times. These parameter combinations are put into Formula (6) for energy consumption calculation. It is finally determined through comparison that a combination with the lowest energy consumption is 0.68 mm-280 MPa-13 times. Parameters of water jets with high efficiency and low energy consumption that are obtained according to the same method are listed in Table 3.

TABLE 3
Results of parameter optimization for efficient cutting by water jets

| | | Pump | Number of |
|---|---|---|---|
| Number | Diameter/(mm) | pressure/(MPa) | cuts/(times n) |
| 41 | 0.50 | 280 | 11 |
| 42 | 0.50 | 280 | 14 |
| 43 | 0.60 | 280 | 13 |
| 44 | 0.68 | 280 | 13 |
| 45 | 0.68 | 380 | 14 |

In conclusion, based on the stepwise cyclic cutting, a general framework of the method for efficiently cutting reinforced concrete by using the combined cutterhead is determined, and related mechanical and tunneling parameters are provided. In addition, based on the abrasive water jet parameter optimization, the parameters of water jets with high efficiency and low energy consumption are obtained, ensuring consistent cutting performance of water jets with different polar radii, and further improving tunneling performance of the combined cutterhead.

### Example 2

The present example provides a combined cutterhead-based method for cutting reinforced concrete, including:
controlling a combined cutterhead to perform stepwise cyclic cutting on the reinforced concrete; wherein,
in each cutting cycle, first controlling the combined cutterhead to rotate without advancing, to perform a plurality of times of cutting by using abrasive water jets, for a total depth of joint-cuttings of a reinforced concrete structure to reach a preset depth; and then controlling the abrasive water jets to be turned off, controlling shield cutters that cooperate with the abrasive water jets to implement same-trajectory cutting, and controlling remaining shield cutters to break concrete between rebar breakpoints and separate out rebar.

In the case of the plurality of times of cutting, different numbers of cuts are set for abrasive water jets with different mounting polar radii, and depths of the joint-cuttings on the reinforced concrete structure that are made by the abrasive water jets are adjusted.

It should be noted herein that an optimization process of corresponding control parameters of the combined cutterhead is as described in Embodiment 1, and details are not described herein again.

The foregoing descriptions are merely preferred embodiments of the present invention and are not intended to limit the present invention. A person skilled in the art may make various modifications and changes of the present invention. Any modification, equivalent replacement, or improvement made within the spirit and principle of the present invention shall fall within the protection scope of the present invention.

1-10. (canceled)

11. A combined cutterhead-based system for cutting reinforced concrete, comprising:
a combined cutterhead, and
a control unit,
wherein,
the combined cutterhead is of an abrasive water jet-mechanical combined cutterhead for shield machine, and the control unit is configured to control the combined cutterhead to perform stepwise cyclic cutting on a reinforced concrete; and
in each cutting cycle, the control unit is configured to: first control the combined cutterhead to rotate without advancing, to perform a plurality of times of cutting by using abrasive water jets, for a total depth of joint-cuttings on a reinforced concrete structure to reach a preset depth; then to control the abrasive water jets to be turned off, to control shield cutters that cooperate with the abrasive water jets to implement a same-trajectory cutting, and to control remaining shield cutters to break concrete between rebar breakpoints and separate out rebar; wherein,
determining value ranges of key parameters for a rebar cutting by the abrasive water jets by using a rebar joint-cutting depth as an evaluation indicator based on obtained test data of the rebar cutting;
fitting the key parameters for the rebar cutting by the abrasive water jets to obtain a model for predicting the rebar joint-cutting depth, and an equation of the model for predicting the rebar joint-cutting depth is:
Dⱼ=k₁nv^{k}^{₂}h^{k}^{₃}p^{k}^{₄}d^{k}^{₅};
wherein, Dⱼ represents a predicted rebar joint-cutting depth, k₁-k₅ are fitting coefficients, v is a transverse velocity, P is a pump pressure, h is a standoff height, d is a nozzle diameter, and n is number of cuts; and
calculating a number of cuts of each water nozzle with each diameter-pump pressure combination in the each cutting cycle based on grouping of estimated ranges of the diameter of the water nozzle and the pump pressure, the model for predicting the rebar joint-cutting depth obtained through the fitting, and an actual cutting depth of the abrasive water jets in the each cutting cycle, and making a list, to obtain a diameter-pump pressure-number of cuts combination that meets a cutting requirement.

12. The combined cutterhead-based system for cutting reinforced concrete according to claim 11, wherein the control unit is configured to, where there is a plurality of times of cutting, set different numbers of cuts for the abrasive water jets with different mounting polar radii, and adjust depths of the joint-cuttings on the reinforced concrete structure that are made by the abrasive water jets.

13. The combined cutterhead-based system for cutting reinforced concrete according to claim 11, wherein a first cutting depth obtained by using the abrasive water jets is greater than a second cutting depth obtained by using the shield cutters that cooperate with the abrasive water jets, and a difference between the first and the second cutting depth is less than a diameter of the rebar.

14. The combined cutterhead-based system for cutting reinforced concrete according to claim 11, wherein a standoff height of a water nozzle for abrasive water jet is a sum of a structural standoff height and a standoff height formed in a cutting process, wherein the standoff height formed in the cutting process=a cutting depth obtained by using the abrasive water jets−a cutting depth obtained by using the shield cutters that cooperate with the abrasive water jets.

15. The combined cutterhead-based system for cutting reinforced concrete according to claim 11, wherein the key parameters for the rebar cutting by the abrasive water jets comprise the transverse velocity, the pump pressure, the standoff height, the nozzle diameter, the number of cuts, and an abrasive concentration.

16. The combined cutterhead-based system for cutting reinforced concrete according to claim 11, wherein when water nozzles with a plurality of diameter-pump pressure-number of cuts combinations are obtained, a combination with the smallest energy consumption calculated value is finally determined through energy consumption calculation.

17. A combined cutterhead-based method for cutting reinforced concrete, being implemented in the combined cutterhead-based system for cutting reinforced concrete according to claim 11, and comprising:
controlling a combined cutterhead to perform stepwise cyclic cutting on the reinforced concrete; and
in each cutting cycle, first controlling the combined cutterhead to rotate without advancing, to perform a plurality of times of cutting by using abrasive water jets, for a total depth of joint-cuttings on a reinforced concrete structure to reach a preset depth; and then controlling the abrasive water jets to be turned off, controlling shield cutters that cooperate with the abrasive water jets to implement same-trajectory cutting, and controlling remaining shield cutters to break concrete between rebar breakpoints and separate out rebar.

18. The combined cutterhead-based method for cutting reinforced concrete according to claim 17, wherein when there is a plurality of times of cutting, different numbers of cuts are set for the abrasive water jets with different mounting polar radii, and depths of the joint-cuttings on the reinforced concrete structure that are made by the abrasive water jets are adjusted.
